(19) United States
(12) Patent Application Publication
(10) Pub. No.: US 2009/0237828 A1
(43) Pub. Date: Sep. 24, 2009

(54) TAPE DEVICE DATA TRANSFERRING METHOD AND TAPE MANAGEMENT SYSTEM

(75) Inventor: Norichika Hatabe, Hiratsuka (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/119,536

(22) Filed: May 13, 2008

(30) Foreign Application Priority Data
Mar. 19, 2008 (JP) 2008-072041

(51) Int. Cl. G11B 15/18

(52) U.S. Cl. 360/71

(57) ABSTRACT

A data transferring method is provided which can perform a data transfer without stopping transactions, without introducing a new device or without halting an access to a tape device by a higher-level device as would otherwise be required by a data transfer procedure. A technology is provided whereby a host computer controls an access request to a tape volume by managing and using information about source/destination tape devices (e.g., magnetic tape library management table and virtual tape management table) or data transfer state in a journal. As a result, even if an access request is issued from other device to a tape volume currently being data-transferred, the access can be made to the tape volume of interest without stopping transactions, i.e., a data transfer can be realized without an interruption of service.

### INCORPORATION BY REFERENCE

The present application claims priority from Japanese application JP2008-072041 filed on Mar. 19, 2008, the content of which is hereby incorporated by reference into this application.

### BACKGROUND OF THE INVENTION

1. Field of the Invention

The present invention relates to a technology for transferring data of a tape device capable of transferring data in a non-stop state.

2. Description of the Related Art

Computer systems generally use magnetic discs or magnetic tapes as media for data storage. Magnetic discs are used to record data that are frequently used because they are capable of a so-called random access that allows direct access to data recorded at arbitrary locations on the magnetic discs. Magnetic tapes on the other hand are storage media capable of only a so-called sequential access that allows sequential data read or write from the start of the tape, so they are mainly used for such applications as backup of data recorded on magnetic discs and long-term storage of old data. The main reason for using the magnetic tapes for backup and archiving is that a bit cost of the magnetic tapes is lower than that of the magnetic discs and costs less when storing a large volume of data.

However, in recent years, the magnetic tapes are being phased out of service because of its performance and storage capacity and some devices have already been removed from production line. Under these circumstances, as disclosed in JP-A-2005-99971, there is a trend to move systems from the conventional tape devices to virtual tape devices that use magnetic disks to emulate tape devices and to large-capacity, high-speed LTO (Linear Tape Open) devices. This requires transferring data from a source tape volume to a destination tape volume.

As to magnetic discs, JP-A-11-184641 discloses a technique to move data from magnetic discs to other magnetic discs uninterrupted during operation in order to avoid adverse effects on tasks being executed by a host.

Further, in magnetic tape devices, JP-A-2008-27335 discloses a data transferring technique that erases data in a source device after the data is moved to a destination device. With this method, the data transfer can be done without interrupting the business transactions. However, this method makes it necessary to build a storage system that, in addition to a first storage device or source device and a second storage device or destination device, has a new data transferring device for moving data from the first storage device to the second storage device.

### SUMMARY OF THE INVENTION

While JP-A-2008-27335 provides a new data transferring device, it is not preferable to prepare a new device in moving data from one magnetic tape device to another because data transfer is only performed in limited cases where storage devices are introduced. Further, since the technique disclosed by JP-A-2008-27335 does not update file management information in connection with the data transfer, it is necessary to execute such operations as updating file location information in a destination volume after the data transfer is completed.

On the other hand, to execute a data transfer by the conventional method without introducing a new device, the transactions being executed by the host must be interrupted temporarily. Although the magnetic tape device is used mainly for backup, halting accesses, even temporarily, to the magnetic tape device means an interruption to the customer transactions and adverse effects caused by the data transfer operation are great. For customers who need 24-hour on-line transactions, in particular, this temporary service interruption is not tolerable. This raises a technical problem that a system transfer cannot be performed.

It is an object of the present invention to solve the above-mentioned problems and to provide a data transferring method for tape devices to transfer data with no service interruptions, i.e., without interrupting accesses by a higher-level devices to the tape devices during a data transfer procedure, and without introducing a new device. It is also an object of the invention to provide a tape management system.

### BRIEF DESCRIPTION OF THE DRAWINGS

FIG. 1 is a configuration diagram of a tape management system in a first embodiment of the invention.

FIG. 2 is an explanatory diagram showing an example of a tape device conversion table.

FIG. 3 is an explanatory diagram showing an example of a journal.

FIG. 4 is an explanatory diagram showing a magnetic tape library management table and a virtual tape management table.

FIG. 5 is an explanatory diagram showing an example of content of a tape volume in a data transfer interrupted state.

FIG. 6 is a flow chart showing a data transfer operation in response to a data transfer request.

FIG. 7 is a flow chart showing a tape volume access operation in response to a tape volume access request that occurs while data is being transferred.

FIG. 8 is a configuration diagram of a tape management system in a second embodiment of the invention.

FIG. 9 is a flow chart showing a data transfer operation in response to a data transfer request in the second embodiment.

FIG. 10 is an explanatory diagram showing an example of a tape device conversion table in the second embodiment.

### DESCRIPTION OF THE EMBODIMENT

Now, preferred embodiments of this invention (hereinafter referred to simply as embodiments) will be described. It should be noted that the invention is not limited in any way by the embodiments.

### First Embodiment

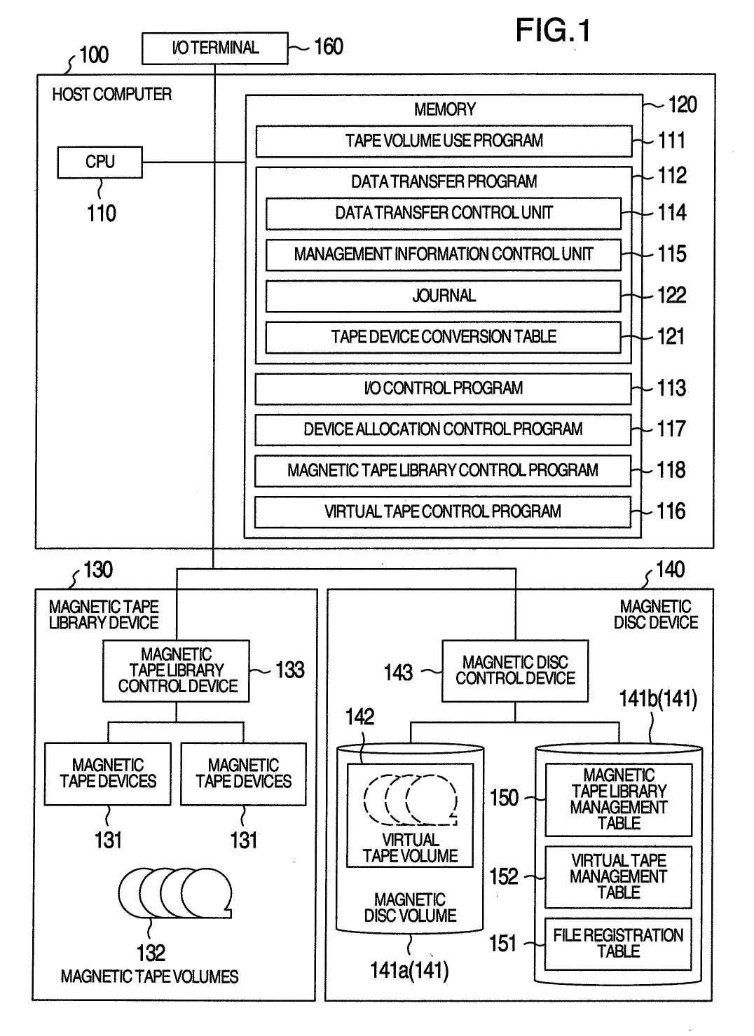

FIG. 1 is a configuration diagram showing a tape management system in the first embodiment. In the system configuration of FIG. 1, a host computer 100 is connected with a magnetic tape library device 130, a magnetic disc device 140 and an input/output terminal 160. This embodiment of the invention requires a system configuration in which one or more host computers 100 are connected with one or more tape devices, such as magnetic tape library devices 130 and virtual tape devices (that are virtually built in a magnetic disc device 140) so that they can communicate with one another. The system configuration of this embodiment also requires that an input/output terminal 160 be connected to the host computer 100 to give the host computer instructions on a data transfer operation and a request for access to a tape volume.

The host computer 100 is a device to process information used by the user and has a CPU (Central Processing Unit) 110, a memory (storage unit) 120 and a connecting unit for connecting these, such as buses and switches. The CPU 110 executes a variety of programs stored in the memory 120. The memory 120 holds various programs to be executed by the host computer 100 and temporary data. The magnetic tape library device 130 and the magnetic disc device 140 store various data to be used by the host computer 100 in executing the programs.

The memory 120 has stored therein a tape volume use program 111, a data transfer program 112, an input/output control program 113 to control requests for access to various external storage devices, and a device allocation control program 117 to allocate a tape volume to a tape device to be used.

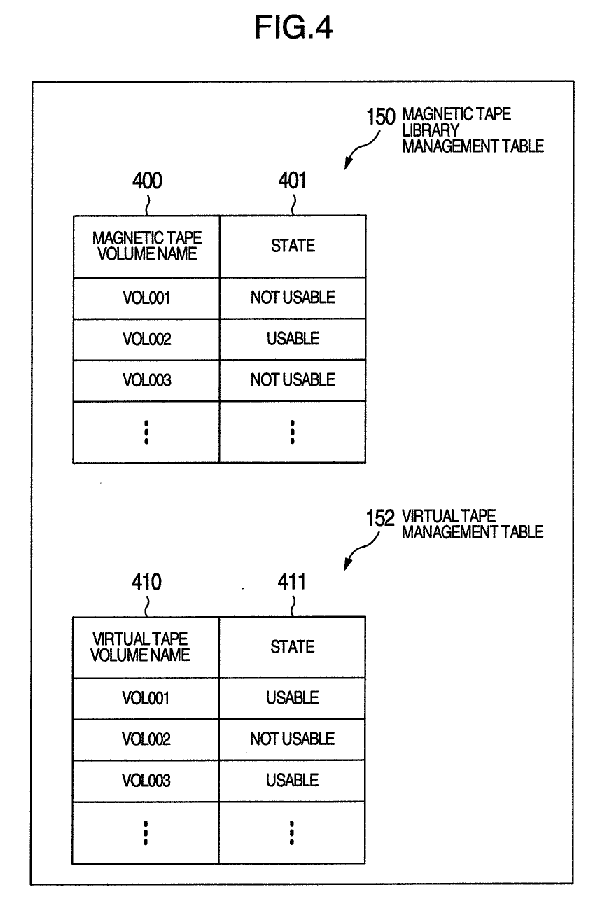

The memory 120 also has stored therein a magnetic tape library control program 118 and a virtual tape control program 116. When a magnetic tape library device 130 is used as the tape device, the magnetic tape library control program 118 is executed to control the magnetic tape library device 130 to operate a magnetic tape library management table 150 (see FIG. 4). When a virtual tape device is used as the tape device, the virtual tape control program 116 is executed to control the virtual tape device to operate a virtual tape management table 152 (see FIG. 4).

The tape volume use program 111 is a user transaction program that uses tape volumes of tape devices connected to the host computer 100.

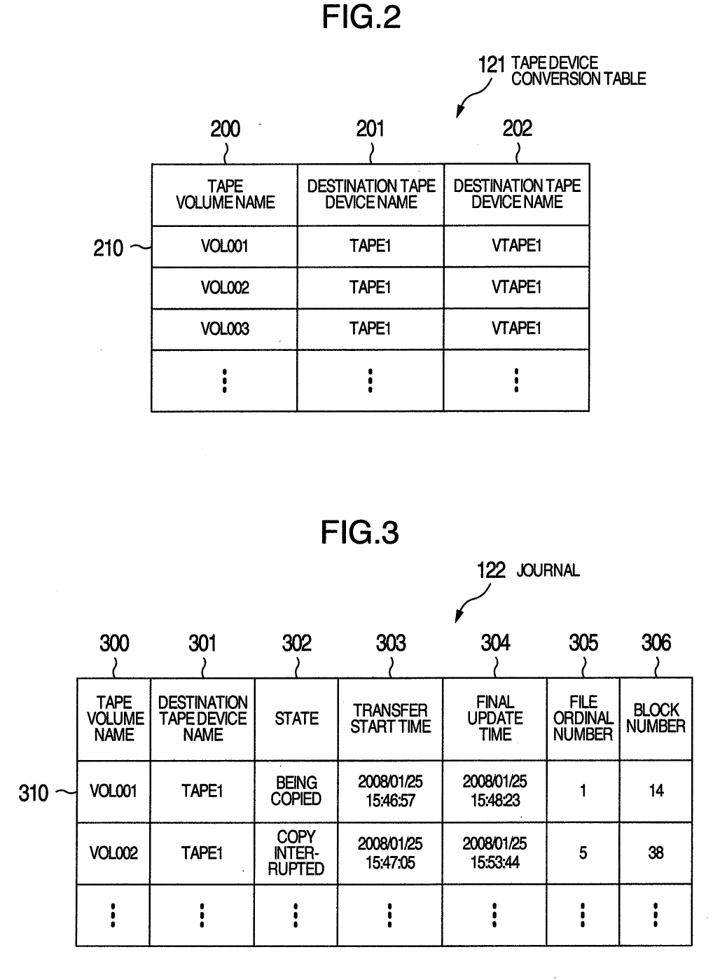

The data transfer program 112 performs a variety of controls to move data among tape volumes of tape devices connected to the host computer 100. It includes a data transfer control unit 114, a management information control unit 115, a tape device conversion table 121 (see FIG. 2) and a journal 122 (see FIG. 3).

The data transfer control unit 114 performs a data transfer operation among tape volumes. At this time, it records a state of data transfer (tape volume names, file ordinal numbers of files whose data is being moved, etc.) in the journal 122. For example, when the user instructs an execution of data transfer from the input/output terminal 160, the data transfer control unit 114 uses the specified source tape device (131 in this embodiment) to connect a tape volume (132 in this embodiment) and execute the input operation. It then moves the input data into a tape volume (142 in this embodiment) that is connected by using the specified destination tape device (virtual tape device in this embodiment). If, while data is being moved, a request for access to the tape volume of interest should occur, the data transfer control unit 114 interrupts the data transfer operation and gives priority to the access request. After the access request for the volume in question is completed, the data transfer control unit 114 resumes the data transfer operation.

If the data transfer control unit 114 receives a user instruction in advance, it generates a tape device conversion table 121 before starting the data transfer operation. Or the data transfer control unit 114 generates a tape device conversion table 121 during execution of the data transfer operation.

In the tape device conversion table 121 are stored names of tape volumes to be used for data transfer and names of source/destination tape devices. If a request for access to the tape volume of interest occurs during the data transfer operation, the tape device conversion table 121 is used to switch between the requests for access to the source and destination tape volumes.

The management information control unit 115, when the data transfer operation is started, manipulates various management information, including the magnetic tape library management table 150 (see FIG. 4), the virtual tape management table 152 (see FIG. 4) and a file registration table 151, to control the access request to the source or destination tape volume, thereby supporting the data transfer. An access request destination can be selected when the user makes a data transfer instruction, making it possible to prevent an access request from being made to fewer source or destination tape devices than is necessary.

For example, if the number of magnetic tape devices 131 is smaller than that of virtual tape devices, a magnetic tape library control program 118 changes the volume information managed by the magnetic tape library management table 150 into an unusable state in order to prevent an access request to the source magnetic tape volume 132 from being made. And a virtual tape control program 116 changes the volume information managed by the virtual tape management table 152 into a usable state in order to allow an access request to the destination virtual tape volume 142 to be accepted. As a result, the access requests to the tape volume from which data is being moved are all changed to access requests to the destination virtual tape volume 142. An access request destination is then controlled by the input/output control program 113, thus preventing a possible stoppage of transaction due to the data transfer.

Conversely, if the number of virtual tape devices is smaller than that of magnetic tape devices 131, the virtual tape control program 116 changes the volume information managed by the virtual tape management table 152 into the unusable state in order to prevent an access request to the destination virtual tape volume 142 from being made. The volume information managed by the magnetic tape library management table 150 is changed by the magnetic tape library control program 118 into the usable state in order to allow an access request to the source magnetic tape volume 132 to be accepted. This causes the access requests to the tape volume into which data is being moved are changed to access requests to the source magnetic tape volume 132. An access request destination is then controlled by the input/output control program 113.

The management information control unit 115, after the data transfer is completed, updates information in the file registration table 151 to access files in the destination tape volume, thus supporting the data transfer operation.

In the file registration table 151 there are stored information on names and locations of files paired with attributes of storage devices. Since the system automatically recognizes the locations of files according to the file registration table 151, the user does not need to perform management on the file locations or specify job control statements. Therefore, after the data transfer is complete, it is necessary to correct the information on the transferred files by changing the source tape volume to the destination tape volume. These file information management is done by the management information control unit 115.

The input/output control program 113 is part of the functions of general OS (Operating System) and executes an input/output operation on the devices connected to the host computer 100.

The device allocation control program 117 is part of the functions of general OS and allocates a medium in which files are stored to devices, so that files specified during the input/output operation can be used. When the tape volume use program 111 is executed, the device allocation control program 117 selects a device and a tape volume to be processed by referring to information on the tape device conversion table 121 and the journal 122 and allocates a device before the input/output control program 113 performs the input/output operation.

For example, if a tape volume to be processed is connected to a source tape device registered with the tape device conversion table 121 (see FIG. 2), the destination of connection is converted into the destination tape device and allocated before using the tape volume of interest. Further, from the information in the journal 122 (see FIG. 3), the source/destination tape volumes are switched in executing the input/output processing.

The magnetic tape library control program 118 performs control on the magnetic tape library device 130 connected to the host computer 100. The magnetic tape library device 130 is controlled by a magnetic tape library control device 133 to operate a built-in robot to automatically mount the magnetic tape volume 132, for which an access request has occurred, on the specified magnetic tape device 131. The magnetic tape volume 132 in the magnetic tape library device 130 is managed by the magnetic tape library management table 150 on a magnetic disc volume 141b (141) connected to the magnetic disc control device 143 in the magnetic disc device 140. The magnetic tape library management table 150 stores medium information such as tape volume names. The magnetic tape library management table 150 is operated by the magnetic tape library control program 118.

The virtual tape control program 116 performs control on the virtual tape devices virtually connected to the host computer 100 and, according to a demand from the input/output control program 113, emulates the tape devices to control the input/output operation on the virtual tape volume 142 using the virtual tape devices. Actual data is stored on the magnetic disc volume 141a (141) connected to the magnetic disc control device 143 in the magnetic disc device 140. The virtual tape volume 142 is managed by the virtual tape management table 152 on the magnetic disc volume 141b. In the virtual tape management table 152 are stored medium information including virtual tape volume names. The virtual tape management table 152 is operated by the virtual tape control program 116.

The input/output terminal 160 can be used to instruct the host computer 100 to process a data transfer to a tape device and an access request to a tape volume.

The magnetic tape library device 130 and the virtual tape device shown in the first embodiment of this invention represent one example configuration having a management table to manage tape volumes as tape devices.

FIG. 2 is an example of the tape device conversion table. The tape device conversion table 121 has registered therein information about tape volume names 200 of tape volumes to be data-transferred, source tape device names 201 and destination tape device names 202. For example, registered information in a row 210 represents a case where a magnetic tape volume 132 with a tape volume name VOL001, which is used in a source tape device name TAPE1 of the magnetic tape devices 131, is transferred to a virtual tape volume 142 with a tape volume name VOL001, which is used in a virtual tape device name VTAPE1.

FIG. 3 shows one example of journal. The journal 122 records information about the processing state of data transfer (transfer state) in units of block. The information includes a tape volume name 300, a source tape device name 301, a status 302, a transfer start time 303, a last update time 304, a file ordinal number 305 and a block number 306. The journal 122 manages status 302, such as “copying” if the data transfer is being executed and “copy interrupted” if the data transfer is interrupted. The file ordinal number 305 stores ordinal numbers of files for which the data transfer has been completed. Likewise, the block number 306 stores block numbers for which the data transfer has been finished. For example, a row 310 shows that a tape volume name VOL001 of a source tape device name TAPE1 is “being copied” and that the data transfer has been completed up to block number 14 of the file ordinal number 1.

FIG. 4 is an explanatory diagram showing one example of a magnetic tape library management table and a virtual tape management table. The magnetic tape library management table 150 stores information used to manage the magnetic tape volumes 132 in the magnetic tape library devices 130. More specifically, what is registered with the magnetic tape library management table 150 includes magnetic tape volume names 400 to be managed and statuses 401 indicating whether a particular magnetic tape volume 132 is usable or not usable.

Likewise, the virtual tape management table 152 stores information used to manage the virtual tape volumes 142 in the virtual tape devices. More specifically, the information registered includes virtual tape volume names 410 to be managed and statuses 411 indicating whether a particular virtual tape volume 142 is usable or not usable.

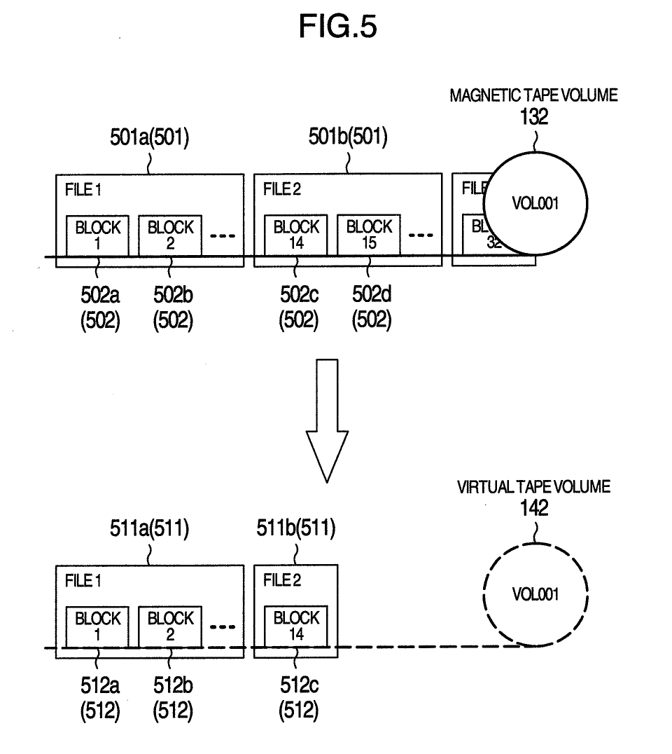

FIG. 5 is an explanatory diagram showing an example content of a tape volume whose data transfer operation is halted temporarily. If during data transfer operation an access request is made to a tape volume being processed, the data transfer is interrupted and an access request is given priority. So, the destination tape volume may become interrupted in units of block. For example, on a magnetic tape volume 132 of a tape volume name VOL001 there are stored a plurality of files 501 (e.g., file 501a of file ordinal number 1 (file 1) and file 501b of file ordinal number 2 (file 2), with each file 501 made up of a plurality of blocks 502 (e.g., blocks 502a, 502b). In this case, if, while data of “file ordinal number 2, block number 14” (as indicated by 310 of FIG. 3) on the magnetic tape volume (VOL001) 132 is being transferred, an access request to the tape volume being processed occurs, the status 302 is changed from “being copied” to “copy interrupted” after the data transfer of the block being processed is finished, thus interrupting the data transfer operation. The status of the destination virtual tape volume 142 at this time is that files 511 have been stored up to block number 14 of block 512 of file ordinal number 2.

The first embodiment has the following features. That is, when the input/output terminal 160 makes an access request to a tape volume being processed, (1) the data transfer that is being executed by the data transfer program 112 of the host computer 100 can be interrupted in units of block; and (2) the input/output control program 113 of the host computer 100 allows the input/output operation to be executed by changing the tape device and tape volume to be used according to the information on the tape device conversion table 121 and journal 122. These features allow the data transfer to be performed without stopping transactions or without the user having to be aware of the destination/source tape volumes when accessing the tape volumes.

A process of transferring data from a magnetic tape volume 132 in the magnetic tape library device 130 to a virtual tape volume 142 in the virtual tape device will be explained as follows.

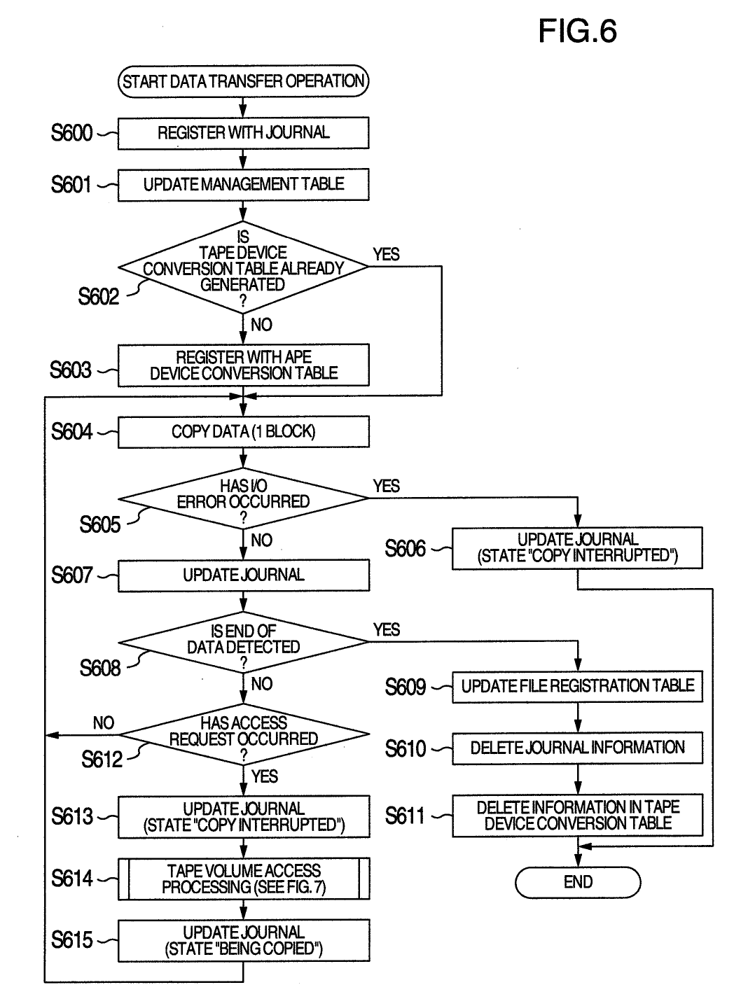

FIG. 6 is a flow chart showing how the data transfer operation is executed when a data transfer request is made. By referring to FIG. 6 (also FIG. 1 as required), the data transfer operation as performed by the CPU 110 will be explained.

When the input/output terminal 160 instructs the host computer 100 to execute a data transfer operation, the CPU 110 of the host computer 100 executes a variety of programs. Here these programs and devices are referred to as programs and processing units concerned. The data transfer program 112 starts the data transfer operation. There are two cases for the data transfer operation: one is when the data transfer operation is executed for the first time on the tape volume of interest; and another is when the data transfer operation is resumed from the middle of the tape volume whose data transfer operation has been suspended as by I/O (Input/Output) errors

First, the data transfer control unit 114 registers in the journal 122 information of the magnetic tape volume 132 to be processed (step S600). If the data transfer is executed for the first time, information is newly registered as a “being copied” state. If the data transfer is executed on the magnetic tape volume 132 which is in a “copy interrupted” state, the existing information is updated to a “being copied” state.

Next, the management information control unit 115 updates the management information (management table) of tape volumes (step S601). The magnetic tape library control program 118 updates the source magnetic tape library management table 150, followed by the virtual tape control program 116 updating the destination virtual tape management table 152. Here it is assumed that the user has selected a method whereby access requests to the tape volume currently being data-transferred are all changed to access requests to destination virtual tape volume 142 and that the user instructs the selected method at time of executing the data transfer operation. Thus, the source magnetic tape volume 132 managed by the source magnetic tape library management table 150 is updated to an unusable state. Further, the destination virtual tape volume 142 managed by the destination virtual tape management table 152 is updated to a usable state. If, when updating the management table, the tape volume of interest is already in the intended state, no updating is done on the management table.

Then, the data transfer control unit 114 checks if information on the magnetic tape volume 132 of interest is already registered (generated) in the tape device conversion table 121 (step S602). If the information is not registered (No in step S602), the data transfer control unit 114 newly registers information with the tape device conversion table 121 (step S603). If it is registered (Yes in step S602), the step S603 is skipped.

Next, the data transfer control unit 114 executes a data copy operation. The data copy is performed one block at a time in order to be able to accept access requests from other devices (step S604). The data transfer control unit 114 checks if there is any I/O error (step S605). If the data copy has been performed with no I/O errors (No in step S605), it updates the information in the journal 122 (step S607). In the journal 122 the data transfer control unit 114 updates the copied block number and the last updated date and time one block at a time and also updates the copied file ordinal number one file at a time. The data transfer control unit 114 checks whether the end of data is reached (step S608). If the end of data is not reached (No in step S608), the data transfer control unit 114 checks if there is any access request from other devices (step S612). If no access request occurs (No in step S612), it returns to step S604.

If an I/O error has occurred during the data copy operation (Yes in step S605), the data transfer control unit 114 updates the information of the journal 122 from the “being copied” state to the “copy interrupted” state (step S606) before exiting the data transfer operation.

If during data copy operation the end of data is detected (Yes in step S608), the data copy is ended. So, the management information control unit 115 updates the file registration table 151 that manages the file locations (step S609) and the data transfer control unit 114 deletes the information (corresponding one record) of the journal 122 associated with the magnetic tape volume 132 of interest (step S610) and also deletes the information (corresponding one record) of the tape device conversion table 121 associated with the tape volume of interest (step S611). Updating the information in the file registration table 151 here involves correcting the information on the data-transferred file from the source magnetic tape volume 132 to the destination virtual tape volume 142.

If during the data copy operation the data transfer control unit 114 detects an access request from other device (Yes in step S612), as when an open request to the file being processed is issued from the input/output control program 113, the data transfer control unit 114 gives priority to the access request by updating the information in the journal 122 about the magnetic tape volume 132 of interest from the “being copied” state to a “copy interrupted” state (step S613).

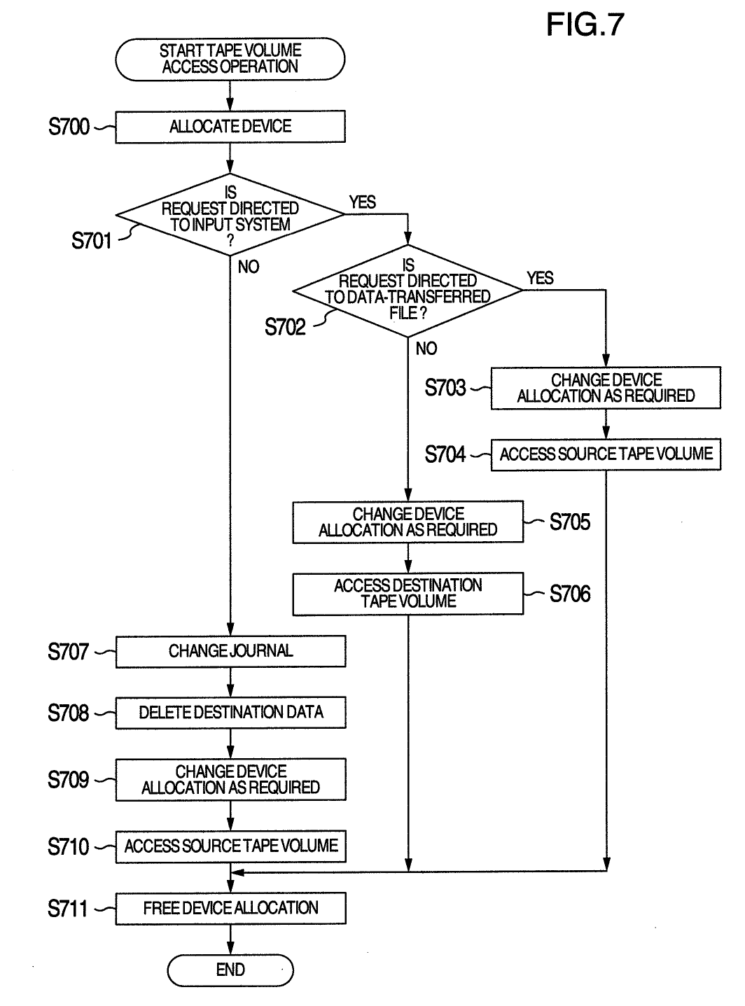

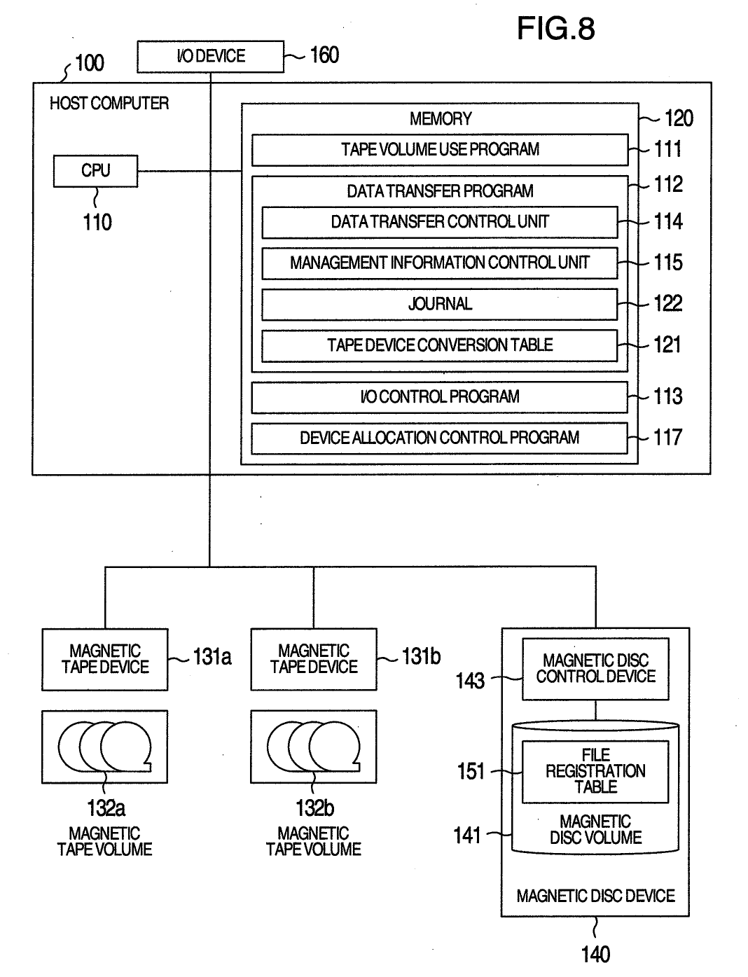

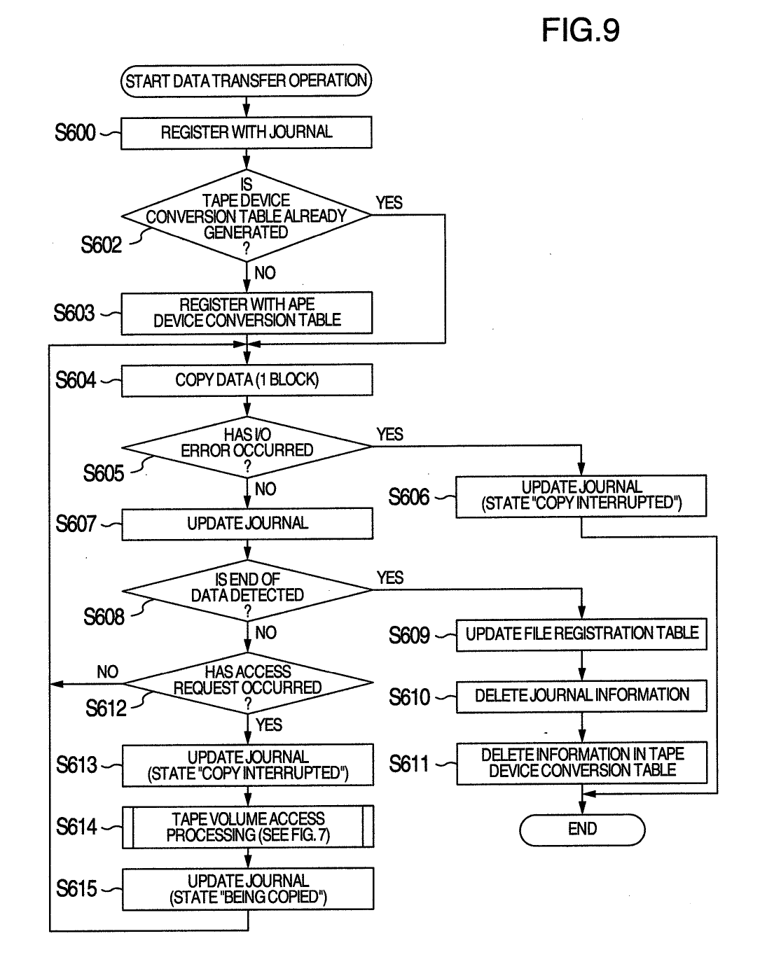

Then the data transfer control unit 114 suspends the data copy operation for the input/output control program 113 to execute the tape volume access operation (see FIG. 7) (step S614). When the volume access operation is ended as by the input/output control program 113 issuing a close request to the file being processed, the data transfer control unit 114 updates the information of journal 122 about the magnetic tape volume 132 of interest from the “copy interrupted” state to the “being copied” state (step S615) to resume the data copy operation (returning to step S604).

The above sequence of steps allows the data transfer operation, that has a function of suspending the data transfer in the event that an access request is made from other device, to be executed by managing the data transfer state.

FIG. 7 is a flow chart showing how a tape volume is accessed when a tape volume access request is issued during a data transfer operation. The tape volume access operation as performed by the CPU 110 will be explained below by referring to FIG. 7 (also FIG. 1 as required).

When, in response to an instruction by the input/output terminal 160, the host computer 100 executes the tape volume use program 111, the input/output control program 113 executed by the CPU 110 of the host computer 100 starts the tape volume access operation.

First, the device allocation control program 117 allocates the access-requested tape volume to a tape device (step S700). At this time, if information on the tape volume of interest is registered with the tape device conversion table 121, the allocation device is changed from the source tape device to the de

Next, the input/output control program 113 checks whether the access request to the file to be processed is for an input system or output system (step S701). If the access request is for the input system (Yes in step S701), the input/output control program 113 then checks whether the request is for a file that has already been transferred (step S702). In the following processing, the control program decides which of the source tape volume or the destination tape volume should be accessed, by using the file ordinal number of the file to be processed and the file ordinal number of the data-transferred file stored in the journal 122.

If the access request is for the data-transferred file (Yes in step S702), the device allocation control program 117 checks if the tape volume currently allocated is the destination tape volume, in order to access data stored in the destination tape volume. If the source tape volume is found allocated, the device allocation control program 117 changes the allocation to the destination tape volume according to a definition of the tape device conversion table 121 (step S703). Then, the input/output control program 113 accesses data stored in the destination tape volume (step S704) before proceeding to step S711.

If the access request is for a file whose data has not been moved (No in step S702), the device allocation control program 117 checks if the currently allocated tape volume is the source tape volume. If the destination tape volume is found allocated, the device allocation control program 117 changes the allocation to the source tape volume according to information on tape volume of interest stored in the tape device conversion table 121 (step S705). Then the input/output control program 113 accesses data stored in the source tape volume (step S706) before moving to step S711.

Let us consider an example case in which the data transfer is suspended in a state shown in FIG. 5. If the request is for an input system having data of “file ordinal number 2, block number 15” on the magnetic tape volume 132, it is an access request to a file 501b which has yet to finish the data transfer. So, the input/output control program 113 accesses data stored in the magnetic tape volume 132. If the request is for an input system having data of “file ordinal number 1, block number 2”, it is an access request to a file 501a which has already finished the data transfer. So, the input/output control program 113 accesses data stored in the virtual tape volume 142.

If the access request concerns an output system (No in step S701), the input/output control program 113 clears (changes) the file ordinal number and block number of the data-transferred file in the tape volume information of the journal 122 (step S707) to delete transferred data from the destination tape volume (step S708).

Then, to access the source tape volume, the device allocation control program 117 checks if the currently allocated tape volume is the source tape volume. If the destination tape volume is found allocated, the device allocation control program 117 changes the allocation to the source tape volume according to the tape volume information in the tape device conversion table 121 (step S709) so that the input/output control program 113 can access the source tape volume (step S710).

The reason that the data in the destination tape volume is deleted in the event an output system access request is made is that the tape volume is sequentially accessed and, once an output is executed, the subsequent data needs to be treated as invalid and that when there are data in both the source and destination tape volumes, it cannot be determined to what extent the data is valid. Therefore, when an output system access request is made for the tape volume being data-transferred, the data transfer operation needs to be re-executed from the scratch.

Take for example a case where a data transfer operation is suspended in a state shown in FIG. 5. If an output system access request is made for data of “file ordinal number 2, block number 151” in the magnetic tape volume 132, the operation performed involves clearing the file ordinal number and block number in the information of the journal 122, deleting the data of the virtual tape volume 142 that has already been data-transferred, and accessing the magnetic tape volume 132. Similarly, if an output system access request is made for data of “file ordinal number 1, block number 2” in the magnetic tape volume 132, the operation performed involves clearing the file ordinal number and block number in the information of the journal 122, deleting the data of the virtual tape volume 142 that has already been data-transferred, and accessing the magnetic tape volume 132.

When the access request to the file of interest is completed, the device allocation control program 117 frees the tape device allocation (step S711). With the above steps, an access request to the tape volume being data-transferred is executed.

### Second Embodiment

FIG. 8 is a configuration diagram of a tape management system in a second embodiment. The difference in configuration between the second embodiment and FIG. 1 is that the tape device connected to the host computer 100 is not the magnetic tape library device 130 but magnetic tape devices 131a, 131b. In the magnetic tape library device 130 (see FIG. 1) and the virtual tape device, normally a tape volume to be used is automatically mounted by the system, making it necessary to manage tape volumes. So these tape devices have a management table (e.g., a magnetic tape library management table 150). On the other hand, in magnetic tape devices (using cartridge type magnetic tape volumes), a tape volume to be used is manually mounted by the user. So they do not use a management table and the tape volumes are managed by the user. In such a case, too, the tape device data transferring method of this invention can be applied. Here, let us explain about a process of data transfer from a magnetic tape volume 132a to a magnetic tape volume 132b.

The magnetic tape devices 131a, 131b in the second embodiment of this invention are just one example and this configuration shows at least one tape device with no management table for managing tape volumes. Thus, the system of the second embodiment may include a magnetic tape device 131a with no tape volume management table and also devices with the management table, such as a magnetic tape library device and a virtual tape device.

As shown in FIG. 8, the second embodiment has a configuration that does not use the magnetic tape library device 130 nor the virtual tape device of the first embodiment. The system configuration shown in FIG. 8 therefore does not use on the memory 120 of the host computer 100 the magnetic tape library control program 118 and the virtual tape control program 116, both of which are used in the system configuration of FIG. 1. It is also noted that magnetic disc volumes 141 of a magnetic disc device 140 do not use a magnetic tape library management table 150 nor a virtual tape management table 152. The magnetic tape devices 131a, 131b have magnetic tape volumes 132a, 132b, respectively. Constitutional parts identical with the corresponding parts shown in FIG. 1 are assigned like reference numbers and their explanations are omitted.

FIG. 9 is a flow chart showing a data transfer operation in the second embodiment performed in response to a data transfer request. Unlike the first embodiment (flow chart of FIG. 6), the second embodiment does not have a step S601. That is, there is no step to operate a management table of tape volumes that would otherwise be performed by the management information control unit 115.

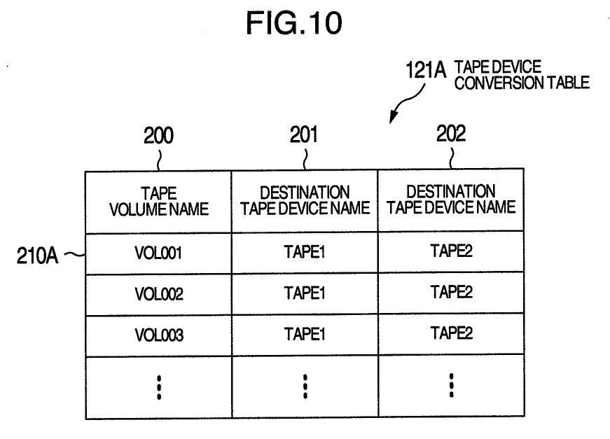

In response to an instruction by the input/output terminal 160, the data transfer program 112 is executed by the CPU 110 of the host computer 100 to perform the data transfer operation. The data transfer control unit 114 checks if information about the magnetic tape volume 132 of interest is already registered (generated) in the tape device conversion table 121 (step S602). If the information is not registered (No in step S602), the data transfer control unit 114 newly registers information with the tape device conversion table 121A (see FIG. 10) (step S603). If it is registered (Yes in step S602), the step S603 is skipped.

FIG. 10 shows an example of a tape device conversion table in the second embodiment. The tape device conversion table 121A has registered therein information about tape volume names 200 of tape volumes to be data-transferred, source tape device names 201 and destination tape device names 202. For example, registered information in a row 210A represents a case where a magnetic tape volume 132a with a tape volume name VOL001, which is used in a source tape device name TAPE1 of the magnetic tape devices 131a, is transferred to a magnetic tape volume 132b with a tape volume name VOL001, which is used in a tape device name TAPE2.

Returning to FIG. 9, the process moves to step S604. Those steps identical with the corresponding ones of FIG. 6 are assigned like reference numbers and their explanations are omitted. After the data transfer is complete, the management information control unit 115 updates information in the file registration table 151 having file locations.

The tape volume access processing performed when a tape volume access request is made during the data transfer operation is the same as that of the first embodiment (process flow of FIG. 7). In response to an instruction by the input/output terminal 160, the host computer 100 executes the input/output control program 113 to control an access request to a tape volume by using the tape device conversion table 121 and journal 122 even if the tape volume of interest is not managed by the management table.

With the above processing, it is also possible to perform a data transfer from a slow, small-capacity, old type magnetic tape volume 132a connected to the magnetic tape device 131a to a fast, large-capacity, new type magnetic tape volume 132b connected to the magnetic tape device 131b. Further, this embodiment allows the data transfer to be performed without stopping transactions or without the user having to be aware of the destination/source tape volumes when accessing the tape volumes.

It should be further understood by those skilled in the art that although the foregoing description has been made on embodiments of the invention, the invention is not limited thereto and various changes and modifications may be made without departing from the spirit of the invention and the scope of the appended claims.

1. In a system having a host, a tape device and a disc device made up of virtual tape volumes of the tape device, a tape device data transferring method for moving data from the tape device to the disc device,
wherein, upon receiving a data transfer instruction from an input/output terminal, the host
registers with a memory tape device conversion information that, for each tape volume to be data-transferred, associates individual volumes of a source tape device with corresponding volumes of a destination disc device,
during data transfer, registers with a journal of the memory a transfer state of each of the tape volumes to be data-transferred, and
upon receiving an access request to the tape device during data transfer, decides whether the access request shall be processed in the tape device or the disc device, based on a registered content of the tape device conversion information and a registered content of the journal, and processes the access request according to the decision made.

2. In a system having a host, a plurality of tape devices and a disc device, a tape device data transferring method for moving data among the plurality of tape devices,
wherein, upon receiving a data transfer instruction from an input/output terminal, the host
registers with a memory tape device conversion information that, for each tape volume to be data-transferred, associates individual volumes of a source tape device with corresponding volumes of a destination tape device,
during data transfer, registers with a journal of the memory a transfer state of each of the tape volumes to be data-transferred, and
upon receiving an access request to the tape device during data transfer, decides whether the access request shall be processed by the source tape device or the destination tape device, based on a registered content of the tape device conversion information and a registered content of the journal, and processes the access request according to the decision made.

3. A tape device data transferring method according to claim 2, wherein, if the access request is a read request from the tape device, the host
checks if the request is directed to a data-transferred file, based on the journal,
if the request is found to be directed to a data-transferred file, processes the access request in the destination volume and,
if the request is found to be not directed to a data-transferred file, processes the access request in the source volume.

4. A tape device data transferring method according to claim 2, wherein, if the access request is a write request to the tape device, the host
deletes file information and block information registered with the journal,
deletes transferred data from the destination volume, and
processes the access request in the source volume.

5. A tape device data transferring method according to claim 2, wherein the disc device has file registration information that registers and manages file locations;
wherein the host
upon detecting the end of data in the data transfer, updates the file registration information and
in response to an access request after the data transfer, processes the access request in the destination volume.

6. A tape device data transferring method according to claim 1, wherein the disc device has first management information that manages usable/unusable states of volumes of the tape device and second management information that manages usable/unusable states of volumes of the disc device;
where the host
upon receiving an instruction specifying a volume of the tape device or a volume of the disc device in connection with the access request to the tape volume currently being data-transferred, updates the first management information and second management information according to the volume-specifying instruction, and
upon receiving an access request to the tape device, processes the access request based on the first management information and the second management information.

7. A tape device data transferring method according to claim 1, wherein, if the access request is a read request from the tape device, the host
checks if the request is directed to a data-transferred file, based on the journal,
if the request is found to be directed to a data-transferred file, processes the access request in the destination volume and,
if the request is found to be not directed to a data-transferred file, processes the access request in the source volume.

8. A tape device data transferring method according to claim 1, wherein, if the access request is a write request to the tape device, the host
deletes file information and block information registered with the journal,
deletes transferred data from the destination volume, and
processes the access request in the source volume.

9. A tape device data transferring method according to claim 1, wherein the disc device has file registration information that registers and manages file locations;
wherein the host
upon detecting the end of data in the data transfer, updates the file registration information and
in response to an access request after the data transfer, processes the access request in the destination volume.

10. A tape management system comprising:
a tape device;
a disc device having virtual volumes of the tape device; and
a host to move data from the tape device to the disc device;
wherein, upon receiving a data transfer instruction from an input/output terminal, the host
registers with a memory tape device conversion information that, for each tape volume to be data-transferred, associates individual volumes of a source tape device with corresponding volumes of a destination disc device,
during data transfer, registers with a journal of the memory a transfer state of each of the tape volumes to be data-transferred, and
upon receiving an access request to the tape device during data transfer, decides whether the access request shall be processed in the tape device or the disc device, based on a registered content of the tape device conversion information and a registered content of the journal, and processes the access request according to the decision made.

11. A tape management system comprising:
a plurality of tape devices;
a disc device; and
a host to move data among the plurality of tape devices;
wherein, upon receiving a data transfer instruction from an input/output terminal, the host
registers with a memory tape device conversion information that, for each tape volume to be data-transferred, associates individual volumes of a source tape device with corresponding volumes of a destination tape device,
during data transfer, registers with a journal of the memory a transfer state of each of the tape volumes to be data-transferred, and
upon receiving an access request to the tape device during data transfer, decides whether the access request shall be processed by the source tape device or the destination tape device, based on a registered content of the tape device conversion information and a registered content of the journal, and processes the access request according to the decision made.

12. A tape management system according to claim 11, wherein, if the access request is a read request from the tape device, the host
checks if the request is directed to a data-transferred file, based on the journal,
if the request is found to be directed to a data-transferred file, processes the access request in the destination volume and,
if the request is found to be not directed to a data-transferred file, processes the access request in the source volume.

13. A tape management system according to claim 11, wherein, if the access request is a write request to the tape device, the host
deletes file information and block information registered with the journal,
deletes transferred data from the destination volume, and
processes the access request in the source volume.

14. A tape management system according to claim 11, wherein the disc device has file registration information that registers and manages file locations;
wherein the host
upon detecting the end of data in the data transfer, updates the file registration information and
in response to an access request after the data transfer, processes the access request in the destination volume.

15. A tape management system according to claim 10, wherein the disc device has first management information that manages usable/unusable states of volumes of the tape device and second management information that manages usable/unusable states of volumes of the disc device;
where the host
upon receiving an instruction specifying a volume of the tape device or a volume of the disc device in connection with the access request to the tape volume currently being data-transferred, updates the first management information and second management information according to the volume-specifying instruction, and
upon receiving an access request to the tape device, processes the access request based on the first management information and the second management information.

16. A tape management system according to claim 10, wherein, if the access request is a read request from the tape device, the host
checks if the request is directed to a data-transferred file, based on the journal,
if the request is found to be directed to a data-transferred file, processes the access request in the destination volume and,
if the request is found to be not directed to a data-transferred file, processes the access request in the source volume.

17. A tape management system according to claim 10, wherein, if the access request is a write request to the tape device, the host
deletes file information and block information Registered with the journal,
deletes transferred data from the destination volume, and
processes the access request in the source volume.

18. A tape management system according to claim 10, wherein the disc device has file registration information that registers and manages file locations;
wherein the host
upon detecting the end of data in the data transfer, updates the file registration information and
in response to an access request after the data transfer, processes the access request in the destination volume.
